(19) United States
(12) Patent Application Publication
(10) Pub. No.: US 2026/0189113 A1
(43) Pub. Date: Jul. 2, 2026

(54) PERMANENT MAGNET SYNCHRONOUS MOTOR

(71) Applicant: Mitsubishi Electric Corporation, Tokyo (JP)

(72) Inventors: Yusuke SAKAMOTO, Tokyo (JP); Masahito MIYOSHI, Tokyo (JP)

(73) Assignee: Mitsubishi Electric Corporation, Tokyo (JP)

(21) Appl. No.: 18/855,350

(22) PCT Filed: May 20, 2022
(86) PCT No.: PCT/JP2022/021016

§ 371 Date: Oct. 9, 2024

(51) Int. Cl. H02K 21/16; H02K 1/14; H02K 3/28

(52) U.S. Cl. CPC H02K 21/16; H02K 1/146; H02K 3/28; H02K 2201/06

(57) ABSTRACT

A permanent magnet synchronous motor includes a stator, multiple teeth disposed equiangularly on the stator, and coils wound around the multiple respective teeth, in which the coils form a three-phase delta connection. There is a closed magnetic circuit in which a magnetic flux generated from a coil wound around one tooth of two specific teeth adjacent to each other passes through end portions of the two specific teeth, penetrates a coil wound around another tooth of the two specific teeth, passes through a core back portion of each of the two specific teeth, and returns back to the coil wound around the one tooth. A magnetic resistance of the closed magnetic circuit when the coils wound around the two specific teeth have a same phase is less than a magnetic resistance of the closed magnetic circuit when the coils wound around the two specific teeth have different phases.

### FIELD

The present disclosure relates to a permanent magnet synchronous motor including a delta connection.

### BACKGROUND

In recent years, a motor having a reduced level of torque ripple is demanded in various applications. A motor having a reduced level of torque ripple is demanded for use in, for example, an industrial servomotor, an elevator hoist, electrically assisted power steering for a vehicle, or the like. The connection configuration for use in a motor driven by a three-phase power supply is generally selected from a star connection and a delta connection, and the delta connection is advantageous for reducing the terminal voltage. Patent Literature 1 discloses a technology relating to a permanent magnet motor including a delta connection.

A permanent magnet motor including a delta connection has an issue of a cyclic current flowing in the circuit in a delta connection. Being a cause of a torque ripple, the cyclic current needs to be reduced as low as possible. Patent Literature 2 discloses a technology in which a means for reducing the spatial harmonic components of magnetic flux density generated by permanent magnets is provided on the rotor to reduce a cyclic current that flows in the delta connection.

### CITATION LIST

### Patent Literature

Patent Literature 1: Japanese Patent Application Laid-open No. 2005-348522
Patent Literature 2: Japanese Patent Application Laid-open No. 2008-301652

### SUMMARY OF INVENTION

### Problem to be Solved by the Invention

However, providing a means for reducing the spatial harmonic components on the rotor will impose a restriction on rotor production. Moreover, providing a means for reducing the spatial harmonic components such as, for example, a skew on the rotor will reduce not only harmonics but also the fundamental. This presents an issue of a decrease in the average torque of the motor.

The present disclosure has been made in view of the foregoing, and it is an object of the present disclosure to provide a permanent magnet synchronous motor that enables reduction of a cyclic current that flows in a delta connection, and reduction of a torque ripple due to the cyclic current, with a smallest possible decrease in the average torque.

### Means to Solve the Problem

In order to solve the above-described problems and achieve the object, a permanent magnet synchronous motor according to the present disclosure includes: a stator; a plurality of teeth disposed equiangularly on the stator; and coils wound in a concentrated winding manner around the plurality of respective teeth, the coils forming a three-phase delta connection. There is a closed magnetic circuit in which a magnetic flux generated from a coil wound around one tooth of two specific teeth adjacent to each other included in the plurality of teeth passes through end portions of the two specific teeth, penetrates a coil wound around another tooth of the two specific teeth, passes through a core back portion of each of the two specific teeth, and returns back to the coil wound around the one tooth. In the closed magnetic circuit, a magnetic resistance of the closed magnetic circuit when the coils wound around the two specific teeth have a same phase is less than a magnetic resistance of the closed magnetic circuit when the coils wound around the two specific teeth have different phases.

### Effects of the Invention

A permanent magnet synchronous motor according to the present disclosure provides an advantage in enabling reduction of a cyclic current that flows in a delta connection, and reduction of a torque ripple due to the cyclic current, with a smallest possible decrease in the average torque.

### BRIEF DESCRIPTION OF DRAWINGS

FIG. 1 is a schematic view illustrating a configuration of a permanent magnet synchronous motor according to a first embodiment.

FIG. 2 is a cross-sectional view of the permanent magnet synchronous motor according to the first embodiment.

FIG. 3 is a first diagram illustrating a connection of the coils included in the permanent magnet synchronous motor according to the first embodiment.

FIG. 4 is a second diagram illustrating the connection of the coils included in the permanent magnet synchronous motor according to the first embodiment.

FIG. 5 is a schematic diagram illustrating the teeth of the stator of the permanent magnet synchronous motor according to the first embodiment.

FIG. 6 is a cross-sectional view illustrating a main portion of the teeth of the stator in an example of the permanent magnet synchronous motor according to the first embodiment.

FIG. 7 is a cross-sectional view illustrating a main portion of the teeth of the stator in another example of the permanent magnet synchronous motor according to the first embodiment.

FIG. 8 is a cross-sectional view illustrating a main portion of the teeth of the stator in a yet another example of the permanent magnet synchronous motor according to the first embodiment.

FIG. 9 is a cross-sectional view illustrating a main portion of the teeth of the stator in the permanent magnet synchronous motor according to a second embodiment.

FIG. 10 is a cross-sectional view illustrating a main portion of the teeth of the stator in the permanent magnet synchronous motor according to a third embodiment.

FIG. 11 is a cross-sectional view illustrating a main portion of the teeth of the stator in the permanent magnet synchronous motor according to a fourth embodiment.

FIG. 12 is a cross-sectional view illustrating a main portion of the teeth of the stator in an example of the permanent magnet synchronous motor according to a fifth embodiment.

FIG. 13 is a cross-sectional view illustrating a main portion of the teeth of the stator in another example of the permanent magnet synchronous motor according to the fifth embodiment.

FIG. 14 is a cross-sectional view illustrating a main portion of the teeth of the stator in another example of the permanent magnet synchronous motor according to the fifth embodiment.

FIG. 15 is a cross-sectional view illustrating a main portion of the teeth of the stator in the permanent magnet synchronous motor according to a sixth embodiment.

FIG. 16 is a cross-sectional view illustrating a main portion of the teeth of the stator in the permanent magnet synchronous motor according to a seventh embodiment.

FIG. 17 is a three-dimensional view illustrating a main portion of a tooth of the stator in the permanent magnet synchronous motor according to an eighth embodiment.

FIG. 18 is a cross-sectional view illustrating a main portion of the stator teeth used in a permanent magnet synchronous motor having a tapered teeth structure.

### DESCRIPTION OF EMBODIMENTS

A permanent magnet synchronous motor according to embodiments will be described in detail below with reference to the drawings.

### First Embodiment

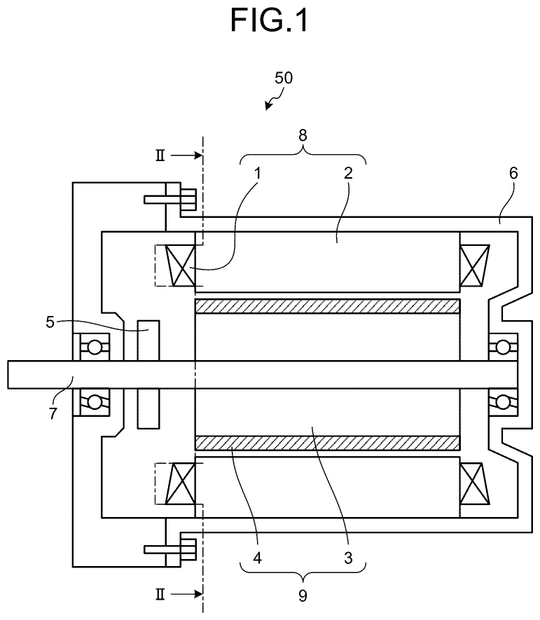

FIG. 1 is a schematic view illustrating a configuration of a permanent magnet synchronous motor 50 according to a first embodiment. The permanent magnet synchronous motor 50 includes a stator 8 and a rotor 9. The stator 8 includes a stator iron core 2 and coils 1 concentratedly wound around the stator iron core 2. The stator 8 is fixed to a frame 6 using a method such as shrink fit or press fit. Part of the stator iron core 2 is in a form of teeth. The permanent magnet synchronous motor 50 includes multiple teeth disposed equiangularly on the stator 8. The coils 1 are wound in a concentrated winding manner each around a corresponding one of the multiple teeth. The permanent magnet synchronous motor 50 is a permanent magnet synchronous motor the coils 1 of which form a three-phase delta connection. The rotor 9 includes a rotor iron core 3 and permanent magnets 4, and is fixed to a shaft 7. On the shaft 7, a rotation sensor 5 for detecting the rotational angle is provided. The rotation sensor 5 may be, for example, a resolver or a component including a magnet and a Hall element.

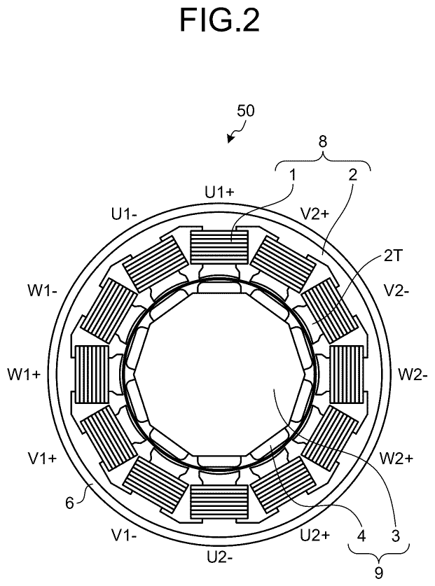

FIG. 2 is a cross-sectional view of the permanent magnet synchronous motor 50 according to the first embodiment. FIG. 2 schematically illustrates a plane of the permanent magnet synchronous motor 50 according to the first embodiment, cut along line II-II of FIG. 1. In the drawings referred to in the following embodiments, reference characters the same as the reference characters of FIG. 1 designate components the same as or equivalent to the components designated by the corresponding reference characters of FIG. 1. As described above, the coils 1 are concentratedly wound around teeth 2T of the stator iron core 2. The coils 1 are wound around the teeth 2T using a scheme called “concentrated winding”. The permanent magnet synchronous motor 50 includes twelve teeth 2T, which are disposed at equal intervals in mechanical angle. The twelve teeth 2T are an example of the multiple teeth. The permanent magnet synchronous motor 50 is a 10-pole 12-slot motor including a total of ten permanent magnets 4 disposed around the rotor iron core 3 and twelve coils 1 disposed along a circumferential direction of the stator 8. The ten permanent magnets 4 are magnetized in a radial direction of the rotor 9. A specific one of the permanent magnets 4 is magnetized in a direction opposite a direction of magnetization of another one of the permanent magnets 4 next to the specific one of the permanent magnets 4.

The permanent magnet synchronous motor 50 includes three-phase coils 1. Each of the three phases is one of phase U, phase V, and phase W.

A reference character U1+, a reference character U1−, a reference character U2+, a reference character U2−, a reference character V1+, a reference character V1−, a reference character V2+, a reference character V2−, a reference character W1+, a reference character W1−, a reference character W2+, and a reference character W2− each having no leader line therewith indicate the coils 1. The sign “+” or “−” is added to distinguish coils subjected to different directions of magnetomotive force generated when a current flows. For example, the coils U1+ and U1− are two of the coils 1 next to each other having a same phase. Use of opposite directions of winding in the two coils U1+ and U1− of the coils 1, or use of a well-conceived connection of connection lines to cause currents to flow in opposite directions through these two of the coils 1, causes magnetomotive force of the coil U1+ to have a direction opposite the direction of the magnetomotive force of the coil U1−. In the first embodiment, the coils 1 are disposed in the order of U1+, U1−, W1−, W1+, V1+, V1−, U2−, U2+, W2+, W2−, V2−, and V2+. Connection of these coils 1 in such manner forms the three-phase permanent magnet synchronous motor 50.

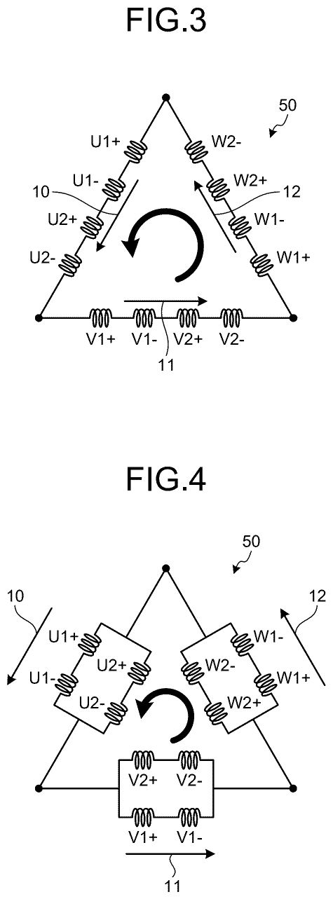

FIG. 3 is a first diagram illustrating a connection of the coils 1 included in the permanent magnet synchronous motor 50 according to the first embodiment. In FIG. 3, the coils U1+, U1−, U2+, and U2−, which are the phase-U coils 1, are connected in series with one another, and the coils 1 of the other two phases are also connected in a similar manner. FIG. 3 illustrates a case of what is called delta connection, in which the coils 1 of the phases are circularly connected. In a delta connection, a cyclic current flows unlike the case of a star connection. The cyclic current is a current that flows to circulate through the three-phase coils 1 as indicated by the black curved arrow in the center of FIG. 3. A relationship Iu=Iv=Iw holds, where Iu represents a phase-U current 10, Iv represents a phase-V current 11, and Iw represents a phase-W current 12, of the cyclic current. Other connection methods include the method illustrated in FIG. 4. FIG. 4 is a second diagram illustrating the connection of the coils 1 included in the permanent magnet synchronous motor 50 according to the first embodiment. The coils U1+ and U1− are connected in series with each other, and the coils U2+ and U2− are connected in series with each other, while a group of coils “U1+ and U1−” and a group of coils “U2+ and U2−” are connected in parallel with each other. Also in this case, a cyclic current flows as indicated by the black curved arrow in the center of FIG. 4 similarly to the case of FIG. 3.

A mechanism of generation of a cyclic current will next be described in detail. Let iᵤ, iᵥ, and i_{w} respectively denote currents flowing in the respective phases of the delta connection, and then iᵤ can be expressed by Equation (1) below, iᵥ can be expressed by Equation (2) below, and i_{w} can be expressed by Equation (3) below.

$$Formula 1$$

$${t}_{u} = {i}_{u 1} + {i}_{cyc} \qquad ( 1 )$$

$$Formula 2$$

$${t}_{v} = {i}_{v 1} + {i}_{cyc} \qquad ( 2 )$$

$$Formula 3$$

$${t}_{w} = {i}_{w 1} + {i}_{cyc} \qquad ( 3 )$$

The symbols iᵤ₁, iᵥ₁, and i_{w1} represent current fundamental components of the respective phases, which are given to have phase differences of 120 degrees from each other in electrical angle. The symbol i_{cyc} represents the cyclic current. The cyclic current is, in general, harmonics each having an order 3n times the order of the fundamental, and has a same value including the phase thereof among the three phases, where n is an integer greater than or equal to 1. The voltage equation for these phases is expressed by Equation (4) below.

$$Formula 4$$

$$[ \begin{matrix}{V}_{u} \\ {V}_{v} \\ {V}_{w}\end{matrix} ] = [ \begin{matrix}R + {pL}_{u} & {M}_{uv} & {M}_{wu} \\ {M}_{uv} & R + {pL}_{v} & {M}_{vw} \\ {M}_{wu} & {M}_{vw} & R + {pL}_{w}\end{matrix} ] [ \begin{matrix}{i}_{u} \\ {i}_{v} \\ {i}_{w}\end{matrix} ] + [ \begin{matrix}{E}_{u} \\ {E}_{v} \\ {E}_{w}\end{matrix} ] \qquad ( 4 )$$

In the equation above, Vᵤ, Vᵥ, and V_{w} represent voltages between terminals of the respective phases; Eᵤ, Eᵥ, and E_{w} represent no-load induced voltages of the respective phases; R represents the resistance of each of the phases; Lᵤ, Lᵥ, and L_{w} represent self-inductances of the respective phases; Mᵤᵥ, M_{vw}, and M_{wu} respectively represent u-v, v-w, and w-u mutual inductances; and p is a differential operator with respect to time.

The voltages between terminals, the currents, and the no-load induced voltages each include the fundamental and harmonic components, and the harmonic components can be separated from the fundamental components. Separation of only the harmonic components from the voltage equation of Equation (4) yields Equation (5) below.

$$Formula 5$$

$$[ \begin{matrix}{V}_{uh} \\ {V}_{vh} \\ {V}_{wh}\end{matrix} ] = [ \begin{matrix}R + {pL}_{u} & {M}_{uv} & {M}_{wu} \\ {M}_{uv} & R + {pL}_{v} & {M}_{vw} \\ {M}_{wu} & {M}_{vw} & R + {pL}_{w}\end{matrix} ] [ \begin{matrix}{i}_{cyc} \\ {i}_{cyc} \\ {i}_{cyc}\end{matrix} ] + [ \begin{matrix}{E}_{uh} \\ {E}_{vh} \\ {E}_{wh}\end{matrix} ] \qquad ( 5 )$$

In the equation above, Vᵤₕ, Vᵥₕ, and V_{wh} represent the harmonic components of the voltages between terminals of the respective phases; and Eᵤₕ, Eᵥₕ, and E_{wh} represent the harmonic components of the no-load induced voltages of the respective phases.

Due to the configuration of a delta connection having the three phases joined circularly, the delta connection is characterized in that the voltages between terminals always sum to 0. That is, Equation (6) below holds.

$$Formula 6$$

$${V}_{u} + {V}_{v} + {V}_{w} = 0 \qquad ( 6 )$$

The relationship of Equation (6) is true of both fundamental and harmonics, and Equation (7) below thus holds.

$$Formula 7$$

$${V}_{uh} + {V}_{vh} + {V}_{wh} = 0 \qquad ( 7 )$$

Calculating the sum of the voltages between terminals of the respective phases from Equation (5) yields Equation (8) below.

$$Formula 8$$

$$0 = 3 {Ri}_{cyc} + 3 {pl}_{α} {i}_{cyc} + ( {E}_{uh} + {E}_{vh} + {E}_{wh} ) \qquad ( 8 )$$

The parameter lₐ represents leakage inductance. Equation (8) is obtained by using the relational formulae of Equation (9) below.

$$Formula 9$$

$${L}_{u} + {M}_{uv} + {M}_{wu} = {l}_{a} \qquad ( 9 )$$

$${L}_{v} + {M}_{uv} + {M}_{vw} = {l}_{a}$$

$${L}_{w} + {M}_{wu} + {M}_{vw} = {l}_{a}$$

Since Eᵤₕ, Eᵥₕ, and E_{wh} have phase differences of 120 degrees from each other, these sums have non-zero values only in orders that are multiples of 3. That is, Equation (10) below is obtained.

$$Formula 10$$

$${E}_{uh} + {E}_{vh} + {E}_{wh} = 3 {{\sum }^{∞}}_{n = 1} {E}_{3 n} sin ( 3 n ω t + {α}_{3 n} ) \qquad ( 10 )$$

The value n is an integer greater than or equal to 1; E₃ₙ represents the amplitude of a 3n-th order harmonic component of the no-load induced voltage; α₃ₙ represents the phase of the 3n-th order harmonic component of the no-load induced voltage; and ω represents the angular velocity in electrical angle. From the foregoing, Equation (8) can be more simply rewritten as Equation (11) below.

$$Formula 11$$

$${Ri}_{cyc} + {l}_{a} ( {pi}_{cyc} ) + {{\sum }^{∞}}_{n = 1} {E}_{3 n} sin ( 3 n θ + {α}_{3 n} ) = 0 \qquad ( 11 )$$

By solving the differential equation of Equation (11), the magnitude of the cyclic current can be obtained as Equation (12) below.

$$Formula 12$$

$${i}_{cyc} = - {{\sum }^{∞}}_{n = 1} = \frac{{E}_{3 n}}{\sqrt{{R}^{2} + {( 3 n ω {l}_{a} )}^{2}}} sin ( 3 n ω t + {α}_{3 n} - a tan \frac{3 n ω {l}_{a}}{R} ) \qquad ( 12 )$$

When the rotational speed of the motor is high to a certain degree, ωlₐ is generally greater than R, thereby allowing the magnitude of the cyclic current to be approximated as Equation (13) below.

$$Formula 13$$

$${i}_{cyc} \sim {{\sum }^{∞}}_{n = 1} = \frac{{E}_{3 n}}{3 n ω {l}_{a}} cos ( 3 n θ + {α}_{3 n} ) \qquad ( 13 )$$

The foregoing shows that a low cyclic current can be achieved by a reduction in E₃ₙ, which is the 3n-th order harmonic of the induced voltage, or by an increase in lₐ, which is leakage inductance.

The simplest method to increase the leakage inductance is to increase the number of turns of each coil. However, when the number of turns is increased to, for example, r times, the leakage inductance increases to r² times, but at the same time, the no-load induced voltage also increases to r times. This causes the magnitude of the cyclic current to decrease to about 1/r time, but since the magnitude of torque ripple depends on the product of the induced voltage and the cyclic current, the magnitude of the torque ripple will remain the same.

An object of the present disclosure is to increase the leakage inductance without changing the induced voltage. The following description will describe a structure of magnetic circuit in the stator that can increase the leakage inductance. The term leakage inductance refers to inductance generated due to a magnetic flux returning back to the coil originating the magnetic flux without penetrating a coil of a phase different from the phase of the coil that has generated that magnetic flux, among the magnetic fluxes generated from the coils of phases of phase U, phase V, and phase W. Accordingly, to increase the leakage inductance, it is desirable to reduce a magnetic flux that penetrates a coil of another phase, and increase a magnetic flux returning back to the coil originating the magnetic flux without penetrating the coil of another phase, among the magnetic fluxes generated from the coils of phases of phase U, phase V, and phase W.

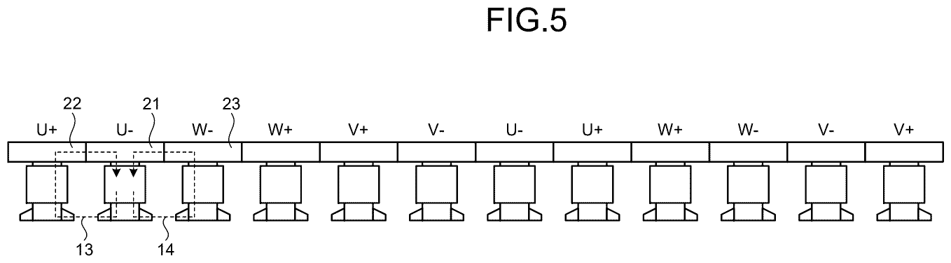

An operation will be described with reference to FIG. 5, of reducing a magnetic flux that penetrates a coil of another phase and of increasing a magnetic flux returning back to the coil originating the magnetic flux without penetrating the coil of another phase, among the magnetic fluxes generated from the coils of phases of phase U, phase V, and phase W. FIG. 5 is a schematic diagram illustrating the teeth of the stator 8 of the permanent magnet synchronous motor 50 according to the first embodiment. For the purpose of easy understanding, FIG. 5 illustrates the twelve teeth as being expanded along a line. A coil is wound around each of the teeth, and the phases of the coils are, from left to right, U+, U−, W−, W+, V+, V−, U−, U+, W+, W−, V−, and V+. Among these, looking at a tooth 21, which is the second tooth from the left, the magnetic flux generated from a coil wound around the tooth 21 has a component that crosses the gap and interacts with the rotor, and in addition thereto, a component that flows from the end portion of the tooth 21 into the end portion of an adjacent tooth, penetrates the coil wound around the adjacent tooth, passes through the core back portion, and then returns back to the tooth 21 originating that component.

The magnetic fluxes relating to the tooth 21 include a magnetic flux passing through a closed magnetic circuit 13 passing through a tooth 22 of the same phase (hereinafter referred to as same-phase tooth 22) adjacent to the tooth 21, and a magnetic flux passing through a closed magnetic circuit 14 passing through a tooth 23 of a different phase (hereinafter referred to as different-phase tooth 23) adjacent to the tooth 21. In contrast to the closed magnetic circuit 14 is contributory to both the self-inductance Lᵤ of phase U and the mutual inductance M_{uw} between phase U and phase W, the closed magnetic circuit 13 is contributory to only the self-inductance Lᵤ of phase U. Accordingly, the leakage inductance can be increased by increasing the magnetic flux passing through the closed magnetic circuit 13 and reducing the magnetic flux passing through the closed magnetic circuit 14.

That is, there is a closed magnetic circuit in which a magnetic flux generated from a coil wound around one tooth of two specific teeth adjacent to each other included in multiple teeth passes through end portions of the two teeth, penetrates a coil wound around another tooth of the two teeth, passes through a core back portion of each of the two teeth, and returns back to the coil wound around the one tooth, which is the tooth originating the magnetic flux. In the closed magnetic circuit, bringing a magnetic resistance of the closed magnetic circuit when the coils wound around these two teeth adjacent to each other have a same phase to less than a magnetic resistance of the closed magnetic circuit when the coils wound around these two teeth adjacent to each other have different phases enables the magnitude of leakage inductance to be increased. This then enables reduction in the magnitude of the cyclic current and in the magnitude of torque ripple due to the cyclic current. The magnetic resistance of a magnetic circuit when the coils wound around two teeth adjacent to each other have a same phase is hereinafter referred to as “magnetic resistance between same-phase coils”, and the magnetic resistance of a magnetic circuit when the coils wound around two teeth adjacent to each other have different phases is hereinafter referred to as “magnetic resistance between different-phase coils”.

A specific structure of the permanent magnet synchronous motor 50 will next be described that causes the magnetic resistance between same-phase coils to be less than the magnetic resistance between different-phase coils.

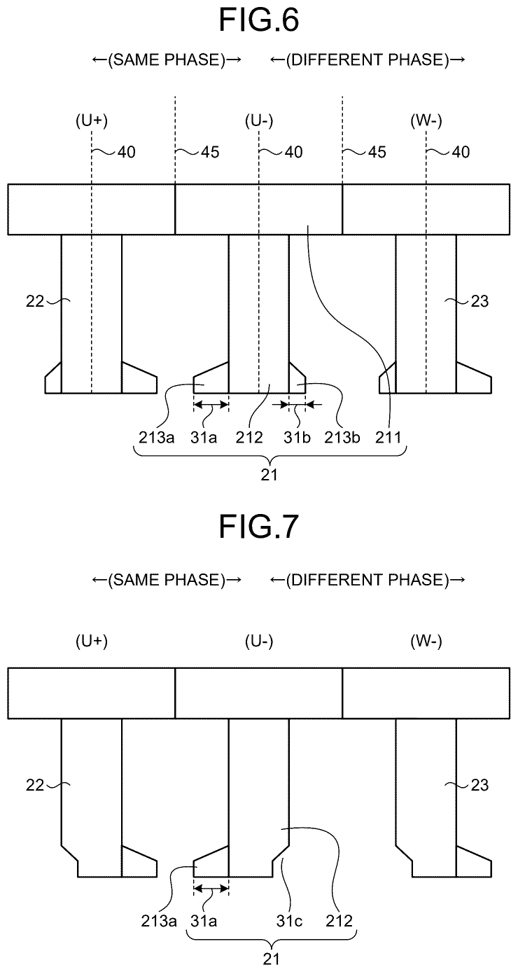

FIG. 6 is a cross-sectional view illustrating a main portion of the teeth of the stator in an example of the permanent magnet synchronous motor 50 according to the first embodiment. For simplicity of illustration, FIG. 6 only illustrates some teeth as being expanded along a line. FIG. 6 only illustrates the three consecutive teeth 22, 21, and 23. Although FIG. 6 omits illustration of coils, a phase-U coil is wound around the tooth 21 illustrated in the center, a phase-U coil is wound around the tooth 22, which is one of the teeth adjacent to the tooth 21, and a phase-W coil is wound around the tooth 23, which is another one of the teeth adjacent to the tooth 21. Use of phase U and phase W as the combination of phases in the three teeth 21, 22, and 23 is merely by way of example. Use of a combination of U and V or a combination of V and W instead of the above combination is also applicable without problem. What is essential is that the tooth 21 and the tooth 22 adjacent to each other have a same phase, and the tooth 21 and the tooth 23 adjacent to each other have different phases.

The tooth 21 can be regarded as a combination of a core back portion 211 connected to the teeth 22 and 23 on the side away from the rotor, a straight portion 212 extending from the core back portion 211 toward the rotor in the radial direction, a flange portion 213a circumferentially extending toward the same-phase tooth at the end nearer to the rotor, of the straight portion 212, and a flange portion 213b circumferentially extending toward the different-phase tooth at the end nearer to the rotor, of the straight portion 212. Note, however, that the core back portion 211, the straight portion 212, the flange portion 213a, and the flange portion 213b are merely names for describing features of the shape of the tooth 21. The core back portion 211, the straight portion 212, and the flange portions 213a and 213b of the tooth 21 do not necessarily need to be separate parts in reality. The tooth 21 may be configured as a monolithic component including the core back portion 211, the straight portion 212, and the flange portions 213a and 213b joined as a single piece, or may be configured in which the core back portion 211, the straight portion 212, and the flange portions 213a and 213b are actually separated.

The flange portion nearer to the same-phase tooth (hereinafter referred to as “on the same-phase side”) has a circumferential direction length 31a, which is longer than a circumferential direction length 31b of the flange portion nearer to the different-phase tooth (hereinafter referred to as “on the different-phase side”). That is, the circumferential direction length of the flange portion circumferentially extending from the end portion nearer to the rotor, of a specific tooth among the multiple teeth, toward the same-phase tooth adjacent to the specific tooth may be longer than the circumferential direction length of the flange portion circumferentially extending from that end portion toward the different-phase tooth adjacent to the specific tooth. The specific tooth is an arbitrary tooth among the multiple teeth. Such configuration enables the magnetic resistance between same-phase coils to be less than the magnetic resistance between different-phase coils.

FIG. 7 is a cross-sectional view illustrating a main portion of the teeth of the stator in another example of the permanent magnet synchronous motor 50 according to the first embodiment. In the formation of FIG. 7, the flange portion 213a circumferentially protruding is provided on the side facing the same-phase tooth 22 adjacent to the tooth 21, while a cutout portion 31c is formed on the side facing the different-phase tooth 23 adjacent to the tooth 21, at the end of the straight portion 212 of the tooth 21. Such configuration also enables the magnetic resistance between same-phase coils to be less than the magnetic resistance between different-phase coils. The use of the cutout portion 31c can be construed as a case where the circumferential direction length 31b of the flange portion nearer to the different-phase tooth in FIG. 6 has a negative value.

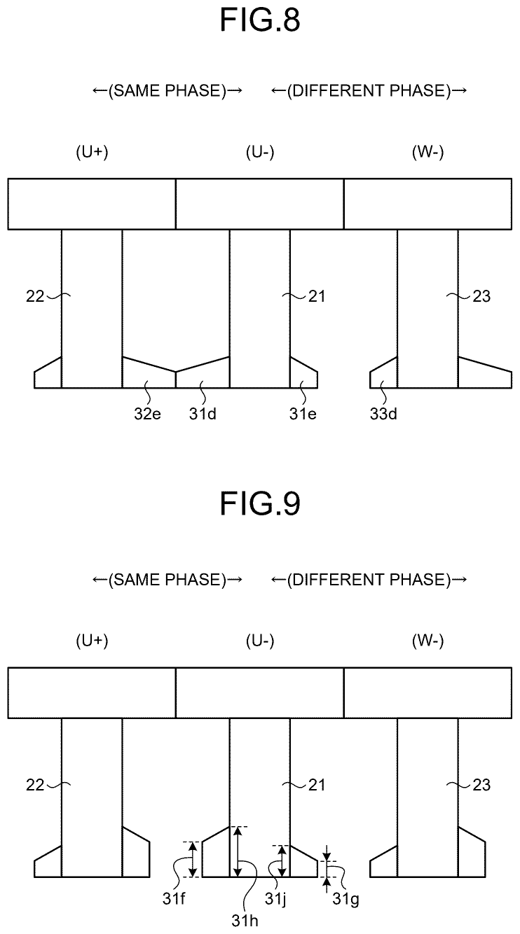

FIG. 8 is a cross-sectional view illustrating the main portion of the teeth of the stator in a yet another example of the permanent magnet synchronous motor 50 according to the first embodiment. The tooth 21 is configured in which, on the same-phase side, a flange portion 31d is joined to a flange portion 32e of the adjacent tooth 22, that is, a closed slot is formed, while, on the different-phase side, a gap exists between a flange portion 31e and a flange portion 33d of the adjacent tooth 23, that is, an open slot is formed. Such configuration also enables the magnetic resistance between same-phase coils to be less than the magnetic resistance between different-phase coils.

In the first embodiment, as described above, there is a closed magnetic circuit in which a magnetic flux generated from a coil wound around one tooth of two specific teeth adjacent to each other included in multiple teeth passes through end portions of the two teeth, penetrates a coil wound around another tooth of the two teeth, passes through a core back portion of each of the two teeth, and returns back to the coil wound around the one tooth, which is the tooth originating the magnetic flux. In the closed magnetic circuit, the magnetic resistance of the closed magnetic circuit when the coils wound around these two teeth adjacent to each other have a same phase is less than the magnetic resistance of the closed magnetic circuit when the coils wound around these two teeth adjacent to each other have different phases. This enables the permanent magnet synchronous motor 50 according to the first embodiment to reduce a cyclic current that flows in a delta connection and to reduce a torque ripple due to the cyclic current, with a smallest possible decrease in the average torque.

The examples given in the first embodiment have one more common feature with respect to the volumes of the teeth. As illustrated in FIG. 6, a line dividing into equal halves the circumferential direction width of the straight portion of each of the teeth 21, 22, and 23 is defined as a tooth center line 40, and a line dividing the tooth center lines 40 of two respective teeth adjacent to each other into equal halves in circumferential direction angle is defined as a tooth boundary line 45. The total volume of the core back portion, of the straight portion, and of the flange portions in an area sandwiched by two of the tooth boundary lines 45 adjacent to each other can be construed as the volume of one tooth. Each of the examples in the first embodiment has a feature that, when one of two teeth adjacent to one specific tooth has a same phase and the other of the two teeth has a different phase, and the volume of the one specific tooth is divided into two portions at the tooth center line 40, the volume included in the portion nearer to the adjacent same-phase tooth with respect to the tooth center line 40, of the volume of the one specific tooth, is greater than the volume included in the portion nearer to the adjacent different-phase tooth with respect to the tooth center line 40, of the volume of the one specific tooth.

That is, when one of two teeth adjacent to a specific tooth of multiple teeth has a same phase as the phase of the specific tooth, and the other of the two teeth adjacent to the specific tooth has a different phase from the phase of the specific tooth, the volume included in the portion nearer to the adjacent same-phase tooth with respect to the tooth center line 40, of the volume of the specific tooth, is greater than the volume included in the portion nearer to the adjacent different-phase tooth with respect to the tooth center line 40, of the volume of the specific tooth. Specifically, in the example of FIG. 6, the volume included in the portion nearer to the adjacent same-phase tooth 22 with respect to the tooth center line 40, of the volume of the tooth 21, is greater than the volume included in the portion nearer to the adjacent different-phase tooth 23 with respect to the tooth center line 40, of the volume of the tooth 21.

### Second Embodiment

In each of the examples given in the first embodiment, the distance between flange portions facing each other of respective teeth adjacent to each other, i.e., a slot opening width, differs between the distance on the same-phase side and the distance on the different-phase side. A main objective of the present disclosure is to reduce a cyclic current and to reduce a torque ripple due to the cyclic current. However, a difference in the slot opening width depending on the position causes breaking of rotational symmetry of the magnetic structure. This may cause a disadvantage such as, for example, an increase in cogging torque at no load or an increase in electromagnetic vibration force under load.

In a second embodiment, all pairs of teeth adjacent to each other in the multiple teeth respectively have slot opening widths therebetween that are equal to one another. The second embodiment will be described below with respect to a formation that provides an advantage similar to the advantage described in the first embodiment while the slot opening widths on the same-phase side and on the different-phase side are the same as each other. In other words, a formation will be described that enables reduction of a cyclic current and reduction of a torque ripple due to the cyclic current by bringing the magnetic resistance between same-phase coils to less than the magnetic resistance between different-phase coils while making the slot opening widths equal to one another for every two teeth adjacent to each other among all the teeth.

FIG. 9 is a cross-sectional view illustrating a main portion of the teeth of the stator in the permanent magnet synchronous motor according to the second embodiment. The tooth 21 is configured in which, in the circumferentially protruding flange portions, a radial direction height 31f in an edge portion most apart from the straight portion on the same-phase side is greater than a radial direction height 31g in an edge portion on the different-phase side, and a radial direction height 31h in a root portion on the same-phase side is greater than a radial direction height 31j in a root portion on the different-phase side. In addition, the radial direction height 31f in the edge portion on the same-phase side is greater than the radial direction height 31j in the root portion on the different-phase side. That is, in the second embodiment, the radial direction height of the flange portion circumferentially extending from the end portion nearer to the rotor of a specific tooth of the multiple teeth toward the same-phase tooth adjacent to the specific tooth is greater than the radial direction height of the flange portion circumferentially extending from that end portion toward the different-phase tooth adjacent to the specific tooth. The specific tooth is an arbitrary tooth among the multiple teeth. The root portions are each a boundary between the straight portion and a flange portion. Such configuration also enables the magnetic resistance between same-phase coils to be less than the magnetic resistance between different-phase coils.

FIG. 9 illustrates an example in which the height in the edge portion and the height in the root portion of the flange portion on the same-phase side are both greater than the respective corresponding heights on the different-phase side. As similar examples, a configuration in which the height in the edge portion of the flange portion on the same-phase side is still greater than the corresponding height on the different-phase side, but the height in the root portion of the flange portion on the same-phase side is equal to the corresponding height on the different-phase side also enables the magnetic resistance between same-phase coils to be less than the magnetic resistance between different-phase coils. A configuration in which the height in the root portion of the flange portion on the same-phase side is still greater than the corresponding height on the different-phase side, but the height in the edge portion of the flange portion on the same-phase side is equal to the corresponding height on the different-phase side also enables the magnetic resistance between same-phase coils to be less than the magnetic resistance between different-phase coils.

### Third Embodiment

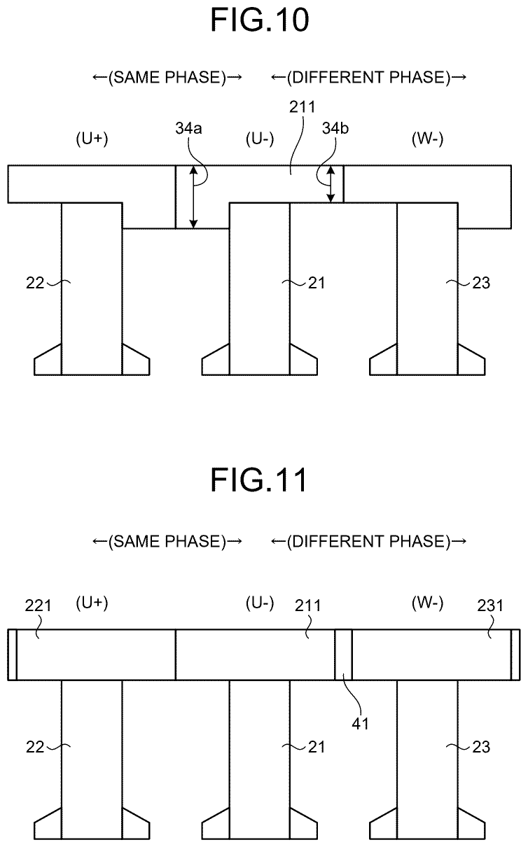

FIG. 10 is a cross-sectional view illustrating a main portion of the teeth of the stator in the permanent magnet synchronous motor according to a third embodiment. The core back portion 211 of the tooth 21 has a radial direction thickness 34a in a portion adjoining the same-phase tooth 22, which is greater than a radial direction thickness 34b in a portion adjoining the different-phase tooth 23. That is, in the third embodiment, a radial direction thickness of the core back portion between a specific tooth of the multiple teeth and the same-phase tooth adjacent to the specific tooth is greater than a radial direction thickness of the core back portion between the specific tooth and the different-phase tooth adjacent to the specific tooth. The specific tooth is an arbitrary tooth among the multiple teeth. Such configuration also enables the magnetic resistance between same-phase coils to be less than the magnetic resistance between different-phase coils.

### Fourth Embodiment

Providing a magnetic resistance-increasing portion in a portion of the closed magnetic circuit on the different-phase side also enables the magnetic resistance between same-phase coils to be less than the magnetic resistance between different-phase coils. Examples of bringing the magnetic resistance between same-phase coils to less than the magnetic resistance between different-phase coils by providing a magnetic resistance-increasing portion will be described in sequence in fourth through sixth embodiments.

FIG. 11 is a cross-sectional view illustrating a main portion of the teeth of the stator in the permanent magnet synchronous motor according to the fourth embodiment. A spacer 41, which is a magnetic resistance-increasing portion, is interposed between the core back portion 211 of the tooth 21 and a core back portion 231 of the different-phase tooth 23 adjacent to the tooth 21. There is no spacer between the core back portion 211 and a core back portion 221 of the same-phase tooth 22 adjacent to the tooth 21. The core back portion 211 and the core back portion 221 are therefore in direct contact with each other. The core back portion 211 has a circumferential direction length decreased by the circumferential direction length of the spacer 41. The spacer 41 is formed of a non-magnetic material or a material having a magnetic resistance higher than the magnetic resistance of the stator core. The spacer 41 is formed by use of, for example, a plastic, a resin, a magnetic paste, or the like. That is, the permanent magnet synchronous motor according to the fourth embodiment includes a spacer interposed between the core back portion of a specific tooth among the multiple teeth and the core back portion of the different-phase tooth adjacent to the specific tooth, where the spacer has a magnetic permeability lower than the magnetic permeability of the material of each of the multiple teeth. Such configuration also enables the magnetic resistance between same-phase coils to be less than the magnetic resistance between different-phase coils.

As a similar example of the fourth embodiment, a configuration may also be used in which a spacer is interposed not only between the core back portion of a specific tooth and the core back portion of the different-phase tooth adjacent to the specific tooth, but also between the core back portion of the specific tooth and the core back portion of the same-phase tooth adjacent to the specific tooth, and the circumferential direction length of the spacer on the same-phase side is less than the circumferential direction length of the spacer on the different-phase side.

### Fifth Embodiment

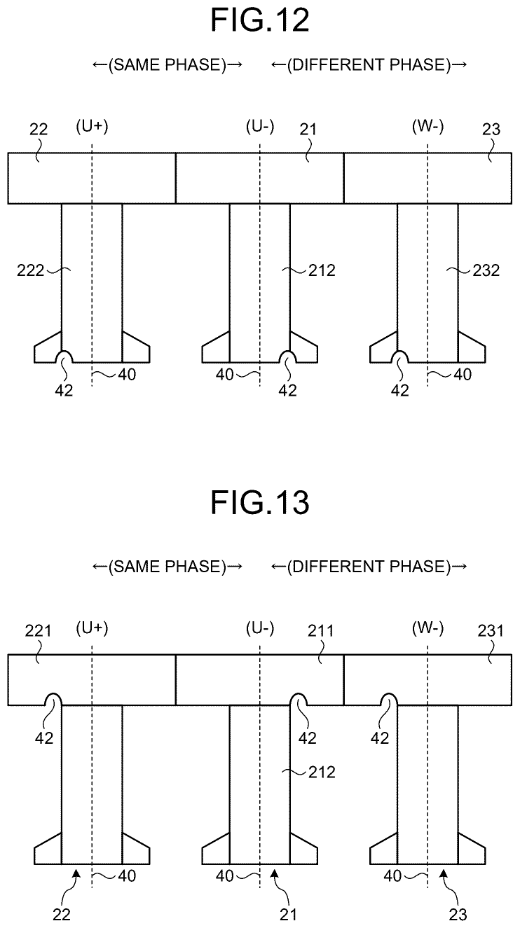

FIG. 12 is a cross-sectional view illustrating a main portion of the teeth of the stator in an example of the permanent magnet synchronous motor according to a fifth embodiment. A groove portion 42 is formed in the end portion nearer to the rotor of each of the teeth 21, 22, and 23. The groove portion 42 of the tooth 21 is formed to have the median point thereof disposed at a position nearer to the different-phase tooth 23 adjacent to the tooth 21 with respect to the tooth center line 40, which is positioned at the circumferential direction center, of the straight portion 212 of the tooth 21. The groove portion 42 of each of the teeth 22 and 23 is also formed to have the median point thereof positioned at a position nearer to the adjacent different-phase tooth with respect to the tooth center line 40, which is positioned at the circumferential direction center, of the corresponding one of the straight portions 222 and 232. That is, in the fifth embodiment, the groove portion 42 is formed in each of the multiple teeth, and the median point of the groove portion 42 is positioned at a position nearer to the different-phase tooth adjacent to a specific tooth on which the groove portion 42 is formed with respect to the tooth center line 40, which is positioned at the center of the circumferential direction width, of the straight portion of the specific tooth. The specific tooth is an arbitrary tooth among the multiple teeth. Such configuration also enables the magnetic resistance between same-phase coils to be less than the magnetic resistance between different-phase coils.

FIG. 12 illustrates an example in which the groove portion 42 is positioned at a position on the boundary between the straight portion and a flange portion. However, as far as the median point of the groove portion 42 is positioned at a position nearer to the adjacent different-phase tooth with respect to the tooth center line 40, the groove portion 42 may be positioned either in the straight portion or in the flange portion. FIG. 12 illustrates an example in which the groove portion 42 has an opening on the rotor side of the end of each of the teeth 21, 22, and 23, but the groove portion 42 may have an opening toward the coil slot, or the groove portion 42 may be replaced with a cavity portion having no opening.

FIG. 13 is a cross-sectional view illustrating a main portion of the teeth of the stator in another example of the permanent magnet synchronous motor according to the fifth embodiment. The groove portion 42 is formed in a portion, which faces the coil slot, of each of the core back portions 211, 221, and 231 of the teeth 21, 22, and 23. The median point of the groove portion 42 is positioned at a position nearer to the adjacent different-phase tooth with respect to the tooth center line 40, which is positioned at the circumferential direction center of the straight portion. Specifically, the median point of the groove portion 42 formed on the tooth 21 is positioned at a position nearer to the different-phase tooth 23 adjacent to the tooth 21 with respect to the tooth center line 40, which is positioned at the circumferential direction center, of the straight portion 212. Such configuration also enables the magnetic resistance between same-phase coils to be less than the magnetic resistance between different-phase coils. Formation of the groove portion 42 in a portion facing the coil slot of each of the core back portions 211, 221, and 231 provides a secondary advantage of enabling the groove portion 42 to be utilized as a winding area.

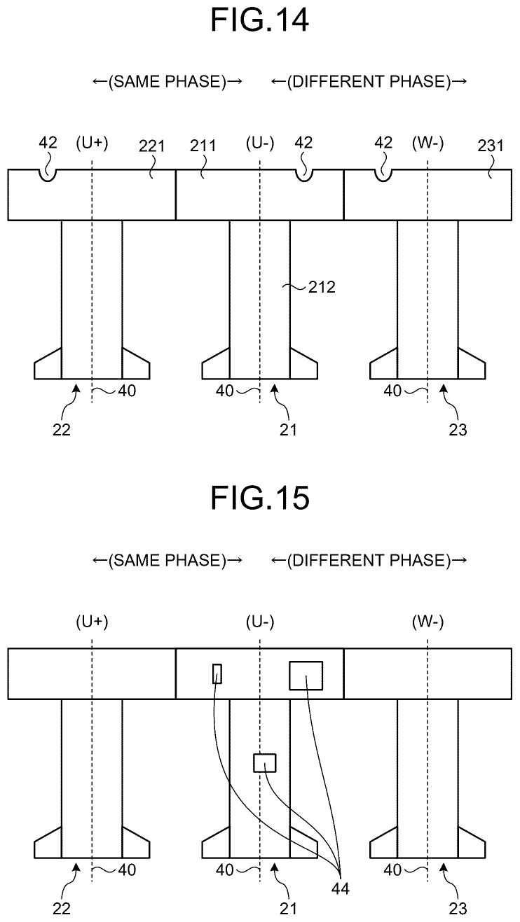

FIG. 14 is a cross-sectional view illustrating a main portion of the teeth of the stator in another example of the permanent magnet synchronous motor according to the fifth embodiment. The groove portion 42 is formed in an outer circumferential portion of each of the core back portions 211, 221, and 231 of the teeth 21, 22, and 23. The median point of the groove portion 42 is disposed at a position nearer to the adjacent different-phase tooth with respect to the tooth center line 40, which is positioned at the circumferential direction center of the straight portion. Specifically, the median point of the groove portion 42 formed on the tooth 21 is disposed at a position nearer to the different-phase tooth 23 adjacent to the tooth 21 with respect to the tooth center line 40, which is positioned at the circumferential direction center, of the straight portion 212. Such configuration also enables the magnetic resistance between same-phase coils to be less than the magnetic resistance between different-phase coils. Formation of the groove portion 42 in an outer circumferential portion of each of the core back portions 211, 221, and 231 provides a secondary advantage of enabling the groove portion 42 to be utilized as a positioning or fixation groove in the assembly process such as stacking of magnetic steel sheets that are materials of the teeth 21, 22, and 23 or insertion of the teeth 21, 22, and 23 into the frame.

In the examples of FIGS. 13 and 14, formation of a cavity portion having no opening rather than the groove portion 42 in each of the core back portions 211, 221, and 231 also enables the magnetic resistance between same-phase coils to be less than the magnetic resistance between different-phase coils.

### Sixth Embodiment

FIG. 15 is a cross-sectional view illustrating a main portion of the teeth of the stator in the permanent magnet synchronous motor according to a sixth embodiment. The tooth 21 is formed using staking. Staking portions 44 include a staking portion positioned nearer to the same-phase tooth 22 adjacent to the tooth 21 with respect to the tooth center line 40, a staking portion positioned nearer to the different-phase tooth 23 adjacent to the tooth 21 with respect to the tooth center line 40, and a staking portion positioned on the tooth center line 40. In consideration of the entire tooth 21, the area of the portions positioned nearer to the different-phase tooth 23 adjacent to the tooth 21 with respect to the tooth center line 40, of the total area of all the staking portions 44, is greater than the area of the portions positioned nearer to the same-phase tooth 22 adjacent to the tooth 21 with respect to the tooth center line 40, of the total area of all the staking portions 44. That is, in the sixth embodiment, a specific tooth among the multiple teeth includes one or more staking portions 44, and the total area of the staking portions 44 included in the portion nearer to the different-phase tooth adjacent to the specific tooth with respect to the tooth center line 40, which is positioned at the center of the circumferential direction width of the straight portion, of the specific tooth is greater than the total area of the staking portions 44 included in the portion nearer to the same-phase tooth adjacent to the specific tooth with respect to the tooth center line 40 of the specific tooth. The specific tooth is an arbitrary tooth among the multiple teeth. Such configuration also enables the magnetic resistance between same-phase coils to be less than the magnetic resistance between different-phase coils.

### Seventh Embodiment

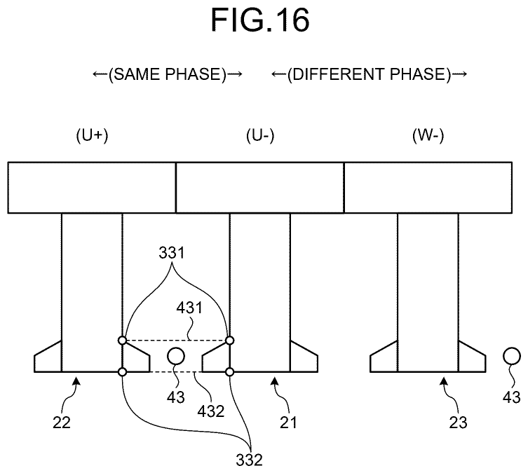

FIG. 16 is a cross-sectional view illustrating a main portion of the teeth of the stator in the permanent magnet synchronous motor according to a seventh embodiment. In the seventh embodiment, an additional magnetic member 43 is disposed between the flange portions positioned between the tooth 21 and the tooth 22 of a same phase adjacent to each other. The additional magnetic member 43 has a shape elongated along the rotational axis direction of the motor, such as a cylindrical shape or a prismatic shape. The additional magnetic member 43 may be a bar-shaped member formed of a single magnetic body or may be a stack of steel sheets stacked along the axial direction. In any of these cases, the permanent magnet synchronous motor according to the seventh embodiment includes the additional magnetic member 43 positioned in a space between a flange portion of a specific tooth among the multiple teeth and a flange portion of the same-phase tooth adjacent to the specific tooth. The specific tooth is an arbitrary tooth among the multiple teeth. Such configuration causes a closed magnetic circuit to be generated in which a magnetic flux flows more easily from a flange portion of the tooth 21 to a flange portion of the same-phase tooth 22 adjacent to the tooth 21 via the additional magnetic member 43, and enables the magnetic resistance between same-phase coils to be less than the magnetic resistance between different-phase coils. To form an effective closed magnetic circuit, the median point of the additional magnetic member 43 is desirably positioned between a straight line 431 and a straight line 432, where the straight line 431 connects together end portions 331 each nearer to the coil in the radial direction at a root of the flange portion facing the adjacent same-phase tooth, and the straight line 432 connects together end portions 332 each nearer to the rotor in the radial direction at a root of such flange portion, of a corresponding one of the tooth 21 and the tooth 22 of a same phase adjacent to each other.

### Eighth Embodiment

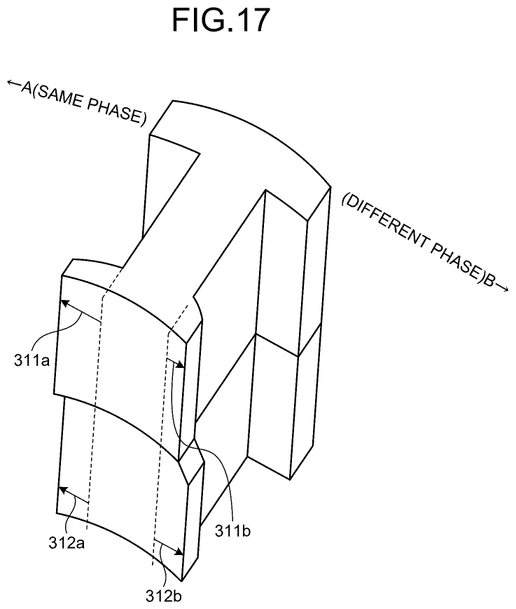

FIG. 17 is three-dimensional view illustrating a main portion of a tooth of the stator in the permanent magnet synchronous motor according to an eighth embodiment. FIG. 17 schematically illustrates a situation of two magnetic steel plates being stacked one on top of another to form a single tooth. Although not illustrated, a same-phase tooth is adjacent to the tooth of FIG. 17 in the direction indicated by “A” of FIG. 17, and a different-phase tooth is adjacent to the tooth of FIG. 17 in the direction indicated by “B” of FIG. 17. The tooth includes two pieces, i.e., an upper-tier piece and a lower-tier piece, separated in the rotational axis direction. The upper-tier piece and the lower-tier piece have different shapes in the flange portion of the tooth. In the upper-tier piece, the flange portion on the same-phase side has a circumferential direction length 311a, which is longer than a circumferential direction length 311b of the flange portion on the different-phase side. In the lower-tier piece, the flange portion on the same-phase side has a circumferential direction length 312a, which is equal to a circumferential direction length 312b of the flange portion on the different-phase side. Such configuration also enables the magnetic resistance between same-phase coils to be less than the magnetic resistance between different-phase coils.

Providing a skew allows an advantage to be expected in reducing cogging torque and electromagnetic vibration force. FIG. 17 illustrates an example in which the flange portions on the same-phase side and on the different-phase side of the upper-tier piece of a two-tier skew have different circumferential direction lengths from each other. Moreover, a tooth having the feature described in each of the second through sixth embodiments will provide an advantage similar to the advantage provided in each of the second through sixth embodiments. FIG. 17 illustrates a tooth having a skew that is a two-tier skew, but a tooth may have a three-or-more tier skew, of which one tier has, or two or more tiers have, the feature that the magnetic resistance between same-phase coils is less than the magnetic resistance between different-phase coils. The skew may be a continuous skew in which the shape of the tooth changes continuously, and the tooth may have the feature that the magnetic resistance between same-phase coils is less than the magnetic resistance between different-phase coils at least in a partial section in the rotational axis direction. The aforementioned continuous skew is an oblique skew.

That is, a specific tooth among the multiple teeth may have a skew structure that differs continuously or discontinuously depending on the position in the rotational axis direction. The specific tooth is an arbitrary tooth among the multiple teeth. In this case, at least in a partial range in the rotational axis direction, the magnetic resistance of a closed magnetic circuit when coils wound around two teeth adjacent to each other including the specific tooth among the multiple teeth have a same phase is less than the magnetic resistance of a closed magnetic circuit when coils wound around such two teeth have different phases.

Two or three or more elements in the examples given in the first through eighth embodiments can be easily practiced in combination.

The first embodiment has been described as having a common feature that when one tooth is divided into two portions at the tooth center line 40, the volume included in the portion nearer to the adjacent same-phase tooth with respect to the tooth center line 40 is greater than the volume included in the portion nearer to the adjacent different-phase tooth with respect to the tooth center line 40. The characteristic that the volume included in the portion nearer to the adjacent same-phase tooth with respect to the tooth center line 40 is greater than the volume included in the portion nearer to the adjacent different-phase tooth with respect to the tooth center line 40 is described hereinafter as “the volume on the same-phase side is greater than the volume on the different-phase side”. The foregoing feature is also applicable to all the examples described in the second through fifth embodiments and in the eighth embodiment. The feature is also applicable to the sixth embodiment that the volume on the same-phase side is greater than the volume on the different-phase side when ignoring the volume of the staking portions 44 in the original tooth volume, and regarding the volume of the portion without the staking portions 44 as the effective tooth volume because the staking portions 44 reduce the basic role of the tooth as a magnetic conductor of forming a closed magnetic circuit for passing a magnetic flux therethrough. The feature is also applicable to the seventh embodiment that the volume on the same-phase side is greater than the volume on the different-phase side when regarding the volume of the additional magnetic member 43 as part of the volume of the corresponding teeth because the additional magnetic member 43 is a component having a role the same as the basic role of the teeth as a magnetic conductor of forming a closed magnetic circuit for passing a magnetic flux therethrough.

The second embodiment has been described in regard to an advantage in equality of the slot opening widths on the same-phase side and on the different-phase side. Making all the slot opening widths equal to one another is easily practiced in each of the examples of the third through seventh embodiments similarly to the second embodiment irrespective of whether two teeth adjacent to each other have a same phase or different phases.

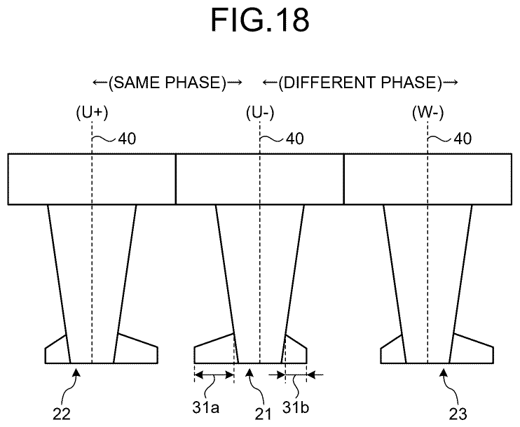

In motor designing, a tapered teeth structure is often selected for purpose of, for example, mitigation of magnetic saturation in teeth portions, increase in the wire space factor in the coil slot area, or the like. In the tapered teeth structure, the circumferential direction width of the straight portion of each tooth changes along the radial direction. The features of the present disclosure are applicable to a permanent magnet synchronous motor having a tapered teeth structure, an example of which is illustrated in FIG. 18. FIG. 18 is a cross-sectional view illustrating a main portion of the teeth of the stator used in a permanent magnet synchronous motor having a tapered teeth structure. The teeth 21, 22, and 23 have a taper shape, in which the circumferential direction width of the straight portion gradually decreases in a direction from the outer circumference to the inner circumference. The circumferential direction length 31a of the flange portion on the same-phase side is longer than the circumferential direction length 31b of the flange portion on the different-phase side. Thus, even a permanent magnet synchronous motor having a tapered teeth structure can bring the magnetic resistance between same-phase coils to less than the magnetic resistance between different-phase coils. The circumferential direction length of a flange portion can be construed as, for example, the distance in the circumferential direction from the end portion nearer to the outer circumference at the root of the flange portion to the edge portion of the flange portion. The tooth center line 40 can be construed as the line dividing into equal halves in angle the boundaries facing the coil slot adjacent to each other, of the straight portion.

With reference to FIG. 18, an example has been described in which a permanent magnet synchronous motor having a tapered teeth structure uses a configuration in which the flange portions on the same-phase side and on the different-phase side have circumferential direction lengths different from each other, described in the first embodiment. Obviously, use of each of the configurations described in the second through eighth embodiments or a combination of two or more of the configurations described in the first through eighth embodiments in a tapered teeth structure also provides an advantage similar to the advantage provided in the first embodiment. A common feature is also applicable to the tapered teeth structure that the volume on the same-phase side is greater than the volume on the different-phase side.

The examples of the foregoing embodiments have each been described using, as an example, a surface permanent magnet synchronous motor (SPMSM), which includes permanent magnets attached on the outer circumferential surface of the rotor. An interior permanent magnet synchronous motor (IPMSM), which includes permanent magnets installed inside the rotor, also provides an advantage similar to the advantages provided in the foregoing embodiments.

In all the examples of the embodiments that have been described above, the motor has 10 poles and 12 slots. Thought is also given below to combinations of another number of poles and another number of slots. For example, when the motor has 8 poles and 12 slots, the coils wound around the twelve teeth are disposed in the order of phases of U+, W+, V+, U+, W+, V+, U+, W+, V+, U+, W+, and V+. Every two teeth adjacent to each other have different phases, that is, there is no adjacent same-phase tooth. The present disclosure is therefore inapplicable. In contrast, for example, when the motor has 8 poles and 9 slots, the coils wound around the nine teeth are disposed in the order of phases of U+, U−, Ut, W+, W−, W+, V+, V−, and V+. Some pairs of two teeth adjacent to each other have a same phase, and some pairs thereof have different phases, and the present disclosure is therefore applicable.

In general, it is known that when a motor having a concentrated winding configuration has a ratio of the number of poles to the number of slots of 3m±1:3m, where m is an integer greater than or equal to 2, the sequence of phases of the coils in the stator includes m consecutive same-phase coils. That is, some pairs of two teeth adjacent to each other have a same phase, and some pairs thereof have different phases, thereby enabling the present disclosure to be applied to a motor having a ratio of the number of poles to the number of slots of 3m±1:3m, where m is an integer greater than or equal to 2.

This is not limited to the case where the ratio of the number of poles to the number of slots is 3m±1:3m. It is known that the sequence of phases of the coils in the stator will simply be opposite, in general, between when P=S−k and when P=S+k, where P is the number of poles, S is the number of slots, and k is an integer greater than or equal to 1. When these sequences include two teeth adjacent to each other of a same phase and two teeth adjacent to each other of different phases, it is thought that application of the present disclosure will result in no significant difference between when P=S−k and when P=S+k in terms of the effect of increasing the leakage inductance from a viewpoint of a closed magnetic circuit in the stator. However, as expressed by Equation (12), the magnitude of the cyclic current having an order of 3n is expressed by the ratio between the magnitude of the 3n-th order harmonic of the induced voltage and the impedance in the electric circuit in a delta connection, i.e., by Equation (14) below.

$$Formula 14$$

$$Ratio = {E}_{3 n} / \sqrt{{R}^{2} + {( 3 n ω {l}_{a} )}^{2}} \qquad ( 14 )$$

E₃ₙ is proportional to the electrical angular velocity ω. Thus, although the magnitude of the cyclic current is little dependent on ω for a sufficiently high rotational speed because R can be regarded as R«3nωlₐ, the magnitude of the cyclic current is positively correlated with ω for a low rotational speed, when the magnitude of R is non-negligible with respect to 3nωlₐ. For a same mechanical rotational speed, a higher number of poles results in a higher electrical angular velocity ω. Accordingly, by comparison between when P=S−k and when P=S+k, the magnitude of the cyclic current can be lower especially at a low rotational speed in the case of P=S−k, i.e., a case of lower number of poles, in other words, a case where the number of poles is less than the number of slots, which case is therefore more suitable.

The configurations described in the foregoing embodiments are merely examples. These configurations may be combined with another known technology, and configurations of different embodiments may be combined together. Moreover, part of such configurations may be omitted or modified without departing from the spirit thereof.

### REFERENCE SIGNS LIST

1 coil; 2 stator iron core; 2T, 21, 22, 23 tooth; 3 rotor iron core; 4 permanent magnet; 5 rotation sensor; 6 frame; 7 shaft; 8 stator; 9 rotor; 10 phase-U current; 11 phase-V current; 12 phase-W current; 13, 14 closed magnetic circuit; 31f radial direction height in edge portion on same-phase side; 31g radial direction height in edge portion on different-phase side; 31h radial direction height in root portion on same-phase side; 31j radial direction height in root portion on different-phase side; 34a radial direction thickness of portion adjoining same-phase tooth; 34b radial direction thickness of portion adjoining different-phase tooth; 31a circumferential direction length of flange portion on same-phase side; 31b circumferential direction length of flange portion on different-phase side; 31d, 31e, 32e, 33d, 213a, 213b flange portion; 31c cutout portion; 40 tooth center line; 41 spacer; 42 groove portion; 43 additional magnetic member; 44 staking portion; 45 tooth boundary line; 50 permanent magnet synchronous motor; 211, 221, 231 core back portion; 212, 222, 232 straight portion; 311a, 312a circumferential direction length of flange portion on same-phase side; 311b, 312b circumferential direction length of flange portion on different-phase side; 331 end portion nearer to coil in radial direction at root of flange portion; 332 end portion nearer to rotor in radial direction at root of flange portion; 431, 432 straight line.

1. A permanent magnet synchronous motor comprising:
a stator;
a plurality of teeth disposed equiangularly on the stator; and
coils wound in a concentrated winding manner around the plurality of respective teeth,
the coils forming a three-phase delta connection, wherein
in a closed magnetic circuit in which a magnetic flux generated from a coil wound around one tooth of two specific teeth adjacent to each other included in the plurality of teeth passes through end portions of the two specific teeth, penetrates a coil wound around another tooth of the two specific teeth, passes through a core back portion of each of the two specific teeth, and returns back to the coil wound around the one tooth,
a magnetic resistance of the closed magnetic circuit when the coils wound around the two specific teeth have a same phase is less than a magnetic resistance of the closed magnetic circuit when the coils wound around the two specific teeth have different phases, and
a number of poles is less than a number of slots.

2.-13. (canceled)

14. A permanent magnet synchronous motor comprising:
a stator;
a plurality of teeth disposed equiangularly on the stator; and
coils wound in a concentrated winding manner around the plurality of respective teeth,
the coils forming a three-phase delta connection, wherein
a specific tooth among the plurality of teeth includes a flange portion circumferentially extending from an end portion nearer to a rotor toward a tooth having a same phase adjacent to the specific tooth and a flange portion circumferentially extending from the end portion toward a tooth having a different phase adjacent to the specific tooth, and the flange portion circumferentially extending toward the tooth having a same phase has a radial direction height greater than a radial direction height of the flange portion circumferentially extending toward the tooth having a different phase, and
the specific tooth is an arbitrary tooth among the plurality of teeth.

15. The permanent magnet synchronous motor according to claim 1, wherein
a core back portion between a specific tooth among the plurality of teeth and a tooth having a same phase adjacent to the specific tooth has a radial direction thickness greater than a radial direction thickness of a core back portion between the specific tooth and a tooth having a different phase adjacent to the specific tooth, and
the specific tooth is an arbitrary tooth among the plurality of teeth.

16. A permanent magnet synchronous motor comprising:
a stator;
a plurality of teeth disposed equiangularly on the stator; and
coils wound in a concentrated winding manner around the plurality of respective teeth,
the coils forming a three-phase delta connection, wherein
a specific tooth among the plurality of teeth includes one or more staking portions,
a total area of the staking portions included in a portion nearer to a tooth having a different phase adjacent to the specific tooth with respect to a tooth center line of the specific tooth is greater than a total area of the staking portions included in a portion nearer to a tooth having a same phase adjacent to the specific tooth with respect to the tooth center line of the specific tooth, the tooth center line being positioned at a center of a circumferential direction width of a straight portion of the specific tooth, and
the specific tooth is an arbitrary tooth among the plurality of teeth.

17. The permanent magnet synchronous motor according to claim 1, wherein
the teeth each include a flange portion circumferentially extending from an end portion nearer to a rotor, of a specific tooth among the plurality of teeth, toward a tooth having a same phase adjacent to the specific tooth, and each include a cutout portion on a side nearer to a tooth having a different phase adjacent to the specific tooth, of the end portion, and
the specific tooth is an arbitrary tooth among the plurality of teeth.

18. The permanent magnet synchronous motor according to claim 1, wherein
a specific tooth among the plurality of teeth includes a flange portion circumferentially extending from an end portion nearer to a rotor toward a tooth having a same phase adjacent to the specific tooth, the flange portion being joined to a flange portion of the tooth having a same phase adjacent to the specific tooth,
a gap exists between a flange portion circumferentially extending from the end portion toward a tooth having a different phase adjacent to the specific tooth and a flange portion of the tooth having a different phase adjacent to the specific tooth, and
the specific tooth is an arbitrary tooth among the plurality of teeth.

19. The permanent magnet synchronous motor according to claim 1, wherein
one of two teeth adjacent to a specific tooth among the plurality of teeth has a same phase as a phase of the specific tooth, and another one of the two teeth adjacent to the specific tooth has a different phase from the phase of the specific tooth, and
a volume included in a portion nearer to the tooth having a same phase adjacent to the specific tooth with respect to a tooth center line, of a volume of the specific tooth, is greater than a volume included in a portion nearer to the tooth having a different phase adjacent to the specific tooth with respect to the tooth center line, of the volume of the specific tooth.

20. The permanent magnet synchronous motor according to claim 1, wherein
a specific tooth among the plurality of teeth includes a flange portion circumferentially extending from an end portion nearer to a rotor toward a tooth having a same phase adjacent to the specific tooth and a flange portion circumferentially extending from the end portion toward a tooth having a different phase adjacent to the specific tooth, and the flange portion circumferentially extending toward the tooth having a same phase has a circumferential direction length longer than a circumferential direction length of the flange portion circumferentially extending toward the tooth having a different phase, and
the specific tooth is an arbitrary tooth among the plurality of teeth.

21. The permanent magnet synchronous motor according to claim 1, wherein
a ratio of the number of poles to the number of slots is 3m±1:3m, m being an integer greater than or equal to 2.

22. The permanent magnet synchronous motor according to claim 14, wherein
a ratio of a number of poles to a number of slots is 3m±1:3m, m being an integer greater than or equal to 2.

23. The permanent magnet synchronous motor according to claim 1, wherein
pairs of teeth adjacent to each other in the plurality of teeth have slot opening widths between the respective pairs, the slot opening widths being equal to one another in all the pairs.

24. The permanent magnet synchronous motor according to claim 14, wherein
pairs of teeth adjacent to each other in the plurality of teeth have slot opening widths between the respective pairs, the slot opening widths being equal to one another in all the pairs.

25. The permanent magnet synchronous motor according to claim 1, further comprising:
a spacer interposed between a core back portion of a specific tooth among the plurality of teeth and a core back portion of a tooth having a different phase adjacent to the specific tooth, the spacer having magnetic permeability lower than magnetic permeability of material of each of the plurality of teeth.

26. The permanent magnet synchronous motor according to claim 14, further comprising:
a spacer interposed between a core back portion of a specific tooth among the plurality of teeth and a core back portion of a tooth having a different phase adjacent to the specific tooth, the spacer having magnetic permeability lower than magnetic permeability of material of each of the plurality of teeth.

27. The permanent magnet synchronous motor according to claim 1, wherein
a groove portion or a cavity portion is formed in each of the plurality of teeth, and the groove portion or the cavity portion has a median point, the median point being positioned at a position nearer to a tooth having a different phase with respect to a tooth center line, the tooth center line being positioned at a center of a circumferential direction width of a straight portion of a specific tooth in which the groove portion or the cavity portion is formed, the tooth having a different phase being adjacent to the specific tooth, and
the specific tooth is an arbitrary tooth among the plurality of teeth.

28. The permanent magnet synchronous motor according to claim 14, wherein
a groove portion or a cavity portion is formed in each of the plurality of teeth, and the groove portion or the cavity portion has a median point, the median point being positioned at a position nearer to a tooth having a different phase with respect to a tooth center line, the tooth center line being positioned at a center of a circumferential direction width of a straight portion of a specific tooth in which the groove portion or the cavity portion is formed, the tooth having a different phase being adjacent to the specific tooth, and
the specific tooth is an arbitrary tooth among the plurality of teeth.

29. The permanent magnet synchronous motor according to claim 1, further comprising:
an additional magnetic member positioned in a space between a flange portion of a specific tooth among the plurality of teeth and a flange portion of a tooth having a same phase adjacent to the specific tooth, wherein
the specific tooth is an arbitrary tooth among the plurality of teeth.

30. The permanent magnet synchronous motor according to claim 14, further comprising:
an additional magnetic member positioned in a space between a flange portion of a specific tooth among the plurality of teeth and a flange portion of a tooth having a same phase adjacent to the specific tooth, wherein
the specific tooth is an arbitrary tooth among the plurality of teeth.

31. The permanent magnet synchronous motor according to claim 1, wherein
a specific tooth among the plurality of teeth has a skew structure, the skew structure differing continuously or discontinuously depending on a position in a rotational axis directions.

32. The permanent magnet synchronous motor according to claim 14, wherein
a specific tooth among the plurality of teeth has a skew structure, the skew structure differing continuously or discontinuously depending on a position in a rotational axis directions.
